(19) United States
(12) Patent Application Publication
(10) Pub. No.: US 2024/0382906 A1
(43) Pub. Date: Nov. 21, 2024

(54) ZEOLITE MEMBRANE COMPLEX AND SEPARATION METHOD

(71) Applicant: NGK INSULATORS, LTD., Nagoya-City (JP)

(72) Inventors: Azumi HIRANE, Nagoya-City (JP); Kenichi NODA, Nagoya-City (JP); Naoto KINOSHITA, Nagoya-City (JP); Takahiro NAKANISHI, Nagoya-City (JP); Nao AMANO, Ichinomiya-City (JP)

(73) Assignee: NGK INSULATORS, LTD., Nagoya-City (JP)

(21) Appl. No.: 18/788,225

(22) Filed: Jul. 30, 2024

Related U.S. Application Data
(63) Continuation of application No. PCT/JP2023/001472, filed on Jan. 19, 2023.

(30) Foreign Application Priority Data
Feb. 28, 2022 (JP) 2022-029615

(51) Int. Cl. B01D 69/02; B01D 61/36; B01D 69/10; B01D 71/02; C02F 1/44; C02F 101/34

(52) U.S. Cl. CPC B01D 69/02; B01D 61/362; B01D 69/108; B01D 71/0281; C02F 1/448; B01D 2325/0231; C02F 2101/34

(57) ABSTRACT

A zeolite membrane complex includes a porous support and a zeolite membrane formed on the support. The zeolite membrane includes a low density layer covering the support and a dense layer covering the low density layer. The dense layer has a content percentage of zeolite crystals higher than that of the low density layer. In a cross section of the zeolite membrane complex perpendicular to a surface of the support, an average aspect ratio of zeolite crystals contained in the dense layer is not smaller than 2 and not larger than 4. When a surface of the zeolite membrane which is a surface of the dense layer is observed from a direction perpendicular to the surface, 20% or more of zeolite crystals among zeolite crystals positioned on the surface each have a triangular shape.

### CROSS-REFERENCE TO RELATED APPLICATIONS

The present application is a continuation application of International Application No. PCT/JP2023/001472 filed on Jan. 19, 2023, which claims priority to Japanese Patent Application No. 2022-029615 filed on Feb. 28, 2022. The contents of these applications are incorporated herein by reference in their entirety.

### TECHNICAL FIELD

The present invention relates to a zeolite membrane complex and a separation method.

### BACKGROUND ART

Conventionally, a zeolite membrane is used as a separation membrane using a molecular sieving function. The zeolite membrane is ordinarily formed on a porous support and handled as a zeolite membrane complex. In a zeolite membrane complex disclosed in, for example, WO 2020/179432 (Document 1), a zeolite membrane has a low density layer covering a support and a dense layer covering the low density layer, and the dense layer has a content percentage of zeolite crystal phase higher than that of the low density layer. In the zeolite membrane complex, high permeability and high separation performance are achieved. Further, a zeolite membrane complex in WO 2019-187640 (Document 2), a zeolite membrane has a zeolite crystal phase formed of a plurality of zeolite crystals and a dense grain boundary phase which is a region between the plurality of zeolite crystals. In the zeolite membrane, by setting the density of at least part of the grain boundary phase to be lower than that of the zeolite crystal phase and setting the width of the grain boundary phase to be not smaller than 2 nm and not larger than 10 nm, high permeability, high separation performance, and high durability are achieved. Furthermore, Japanese Patent Application Laid Open Gazette No. 2004-83375 (Document 3) discloses a manufacturing method of DDR-type zeolite.

The hydrothermal resistance of the zeolite membrane can be evaluated by the degree of decrease in the vacuum before and after the zeolite membrane is immersed in high-temperature water. It is known that zeolite is dissolved in high-temperature water, and generally, the hydrothermal resistance of the zeolite membrane is low. By thickening the zeolite membrane, it is possible to improve the hydrothermal resistance but the water flux disadvantageously decreases. Therefore, a zeolite membrane complex having high water flux and high hydrothermal resistance is required.

### SUMMARY OF THE INVENTION

The present invention is intended for a zeolite membrane complex, and it is an object of the present invention to provide a zeolite membrane complex having high water flux and high hydrothermal resistance.

A first aspect of the present invention is a zeolite membrane complex, and the zeolite membrane complex of the first aspect includes a porous support and a zeolite membrane formed on the support. The zeolite membrane includes a low density layer covering the support and a dense layer covering the low density layer and having a content percentage of zeolite crystals higher than that of the low density layer. In the zeolite membrane complex of the first aspect, an average aspect ratio of zeolite crystals contained in the dense layer is not smaller than 2 and not larger than 4 in a cross section of the zeolite membrane complex perpendicular to a surface of the support. When a surface of the zeolite membrane which is a surface of the dense layer is observed from a direction perpendicular to the surface, 20% or more of zeolite crystals among zeolite crystals positioned on the surface each have a triangular shape.

According to the present invention, it is possible to provide a zeolite membrane complex having high water flux and high hydrothermal resistance.

A second aspect of the present invention is the zeolite membrane complex of the first aspect, in which a ratio of zeolite crystals each having an aspect ratio of 3 or more, among zeolite crystals contained in the dense layer, is not lower than 10% in the cross section of the zeolite membrane complex.

A third aspect of the present invention is the zeolite membrane complex of the first or second aspect, in which an average inclination angle of zeolite crystals contained in the dense layer in a longitudinal direction with respect to the surface of the support is not smaller than 60° and not larger than 90° in the cross section of the zeolite membrane complex.

A fourth aspect of the present invention is the zeolite membrane complex of any one of the first to third aspects, in which a length of a ridgeline on the surface of the zeolite membrane between two points separated from each other on the surface is 1.2 times or more as long as a distance between the two points in the cross section of the zeolite membrane complex.

A fifth aspect of the present invention is the zeolite membrane complex of any one of the first to fourth aspects, in which a Si/Al ratio of zeolite contained in the dense layer is 3 or more.

A sixth aspect of the present invention is the zeolite membrane complex of any one of the first to fifth aspects, in which zeolite contained in the dense layer is an 8-membered ring zeolite.

The present invention is also intended for a separation method. A seventh aspect of the present invention is a separation method, and the separation method of the seventh aspect includes a) preparing the zeolite membrane complex according to any one of the first to sixth aspects and b) supplying a mixed substance containing a plurality of types of gases or liquids to the zeolite membrane complex and causing a substance with high permeability in the mixed substance to permeate the zeolite membrane complex, to be separated from any other substance.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross-sectional view of a zeolite membrane complex;

FIG. 2 is a cross-sectional view enlargedly showing part of the zeolite membrane complex;

FIG. 3 is a cross-sectional view showing the vicinity of a zeolite membrane;

FIG. 4 is a schematic diagram showing a dense layer and a low density layer;

FIG. 5 is a view showing a surface of the zeolite membrane;

FIG. 6 is a flowchart showing a flow of manufacturing the zeolite membrane complex;

FIG. 7A is a view used for explaining formation of the zeolite membrane;

FIG. 7B is a view used for explaining formation of the zeolite membrane;

FIG. 7C is a view used for explaining formation of the zeolite membrane;

FIG. 8 is a graph showing a change in the temperature of a starting material solution during hydrothermal synthesis;

FIG. 9 is a view showing a separation apparatus;

FIG. 10 is a flowchart showing a flow of separating a mixed substance;

FIG. 11 is a view used for explaining measurement of the degree of vacuum;

FIG. 12 is a view showing a surface of a zeolite membrane in Comparative Example; and

FIG. 13 is a schematic diagram showing zeolite crystals contained in the dense layer.

### DETAILED DESCRIPTION

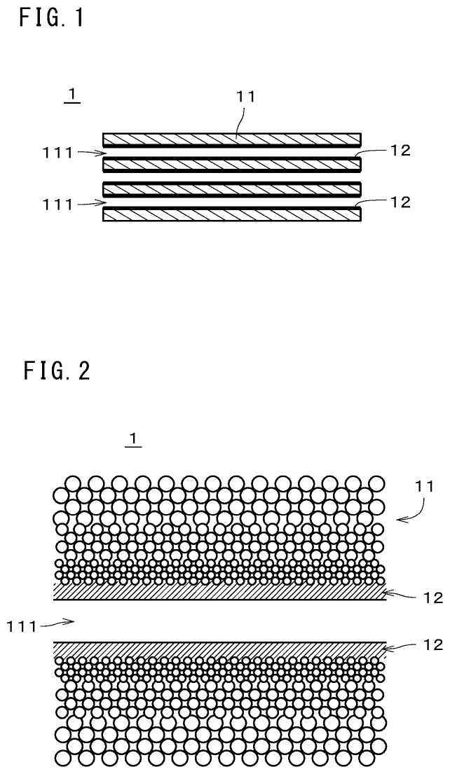

FIG. 1 is a cross-sectional view of a zeolite membrane complex 1. FIG. 2 is a cross-sectional view enlargedly showing part of the zeolite membrane complex 1. The zeolite membrane complex 1 includes a porous support 11 and a zeolite membrane 12 formed on the support 11. A zeolite membrane is at least obtained by forming zeolite on a surface of the support 11 in a membrane form and does not include a membrane obtained by simply dispersing zeolite particles in an organic membrane. In FIG. 1, the zeolite membrane 12 is represented by a thick line. In FIG. 2, the zeolite membrane 12 is hatched. Further, in FIG. 2, the thickness of the zeolite membrane 12 is shown larger than the actual one.

The support 11 is a porous member that gas and liquid can permeate. In the exemplary case shown in FIG. 1, the support 11 is a monolith-type support having an integrally and continuously molded columnar main body provided with a plurality of through holes 111 extending in a longitudinal direction (i.e., a left and right direction in FIG. 1). In the exemplary case shown in FIG. 1, the support 11 has a substantially columnar shape. A cross section perpendicular to the longitudinal direction of each of the through holes 111 (i.e., cells) is, for example, substantially circular. In FIG. 1, the diameter of each through hole 111 is larger than the actual diameter, and the number of through holes 111 is smaller than the actual number. The zeolite membrane 12 is formed on an inner surface of each through hole 111, covering substantially the entire inner surface of the through hole 111.

The length of the support 11 (i.e., the length in the left and right direction of FIG. 1) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) may be adopted only if the materials ensure chemical stability in the process step of forming the zeolite membrane 12 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the zeolite membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the zeolite membrane 12 is formed is, for example, 20% to 50%.

The support 11 has, for example, a multilayer structure in which a plurality of layers with different average pore diameters are layered in a thickness direction. The average pore diameter and the sintered particle diameter in a surface layer including the surface on which the zeolite membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another.

The zeolite membrane 12 is a porous membrane having pores. The zeolite membrane 12 can be used as a separation membrane for separating a specific substance from a mixed substance in which a plurality of types of substances are mixed, by using a molecular sieving function. As compared with the specific substance, any one of the other substances is harder to permeate the zeolite membrane 12. In other words, the permeance of any other substance through the zeolite membrane 12 is smaller than that of the above-described specific substance.

The thickness of the zeolite membrane 12 is, for example, 0.05 μm to 30 μm, preferably 0.1 μm to 20 μm, and more preferably 0.5 μm to 10 μm. When the thickness of the zeolite membrane 12 is increased, the separation performance increases. When the thickness of the zeolite membrane 12 is reduced, the permeance increases. The surface roughness (Ra) of the zeolite membrane 12 is, for example, 5 μm or less, preferably 2 μm or less, more preferably 1 μm or less, and further preferably 0.5 μm or less.

The average pore diameter of the zeolite membrane 12 is, for example, 1 nm or less. The average pore diameter of the zeolite membrane 12 is preferably not smaller than 0.2 nm and not larger than 0.8 nm, more preferably not smaller than 0.3 nm and not larger than 0.7 nm, and further preferably not smaller than 0.3 nm and not larger than 0.6 nm. When the average pore diameter is larger than 1 nm, the separation performance is sometimes reduced. Further, when the average pore diameter is smaller than 0.2 nm, the permeance is sometimes reduced. The average pore diameter of the zeolite membrane 12 is smaller than that of the support 11 in the vicinity of the surface on which the zeolite membrane 12 is formed.

When the maximum number of membered rings of the zeolite forming the zeolite membrane 12 is n, an arithmetic average of the short diameter and the long diameter of an n-membered ring pore is defined as the average pore diameter. The n-membered ring pore refers to a pore in which the number of oxygen atoms in the part where the oxygen atoms and later-described T atoms are bonded to form a ring structure is n. When the zeolite has a plurality of types of n-membered ring pores having the same n, an arithmetic average of the short diameters and the long diameters of all types of n-membered ring pores is defined as the average pore diameter of the zeolite. Thus, the average pore diameter of the zeolite membrane is uniquely determined depending on the framework structure of the zeolite and can be obtained from values disclosed in “Database of Zeolite Structures” [online], internet <URL: http://www.iza-structure.org/databases/> of the International Zeolite Association.

There is no particular limitation on the type of the zeolite forming the zeolite membrane 12, but the zeolite membrane 12 may be formed of, for example, AEI-type, AEN-type, AFN-type, AFV-type, AFX-type, BEA-type, CHA-type, DDR-type, ERI-type, ETL-type, FAU-type (X-type, Y-type), GIS-type, LEV-type, LTA-type, MEL-type, MFI-type, MOR-type, PAU-type, RHO-type, SAT-type, SOD-type zeolite, or the like.

The zeolite membrane 12 contains, for example, silicon (Si). The zeolite membrane 12 may contain, for example, any two or more of Si, aluminum (Al), and phosphorus (P). In this case, as the zeolite forming the zeolite membrane 12, zeolite in which atoms (T-atoms) each located at the center of an oxygen tetrahedron (TO₄) constituting the zeolite include only Si or Si and Al, AlPO-type zeolite in which T-atoms include Al and P, SAPO-type zeolite in which T-atoms include Si, Al, and P, MAPSO-type zeolite in which T-atoms include magnesium (Mg), Si, Al, and P, ZnAPSO-type zeolite in which T-atoms include zinc (Zn), Si, Al, and P, or the like can be used. Some of the T-atoms may be replaced by other elements.

When the zeolite membrane 12 contains Si atoms and Al atoms, the Si/Al ratio (molar ratio) in the zeolite membrane 12 is, for example, not less than 1 and not more than 100,000. The Si/Al ratio is preferably 3 or more, more preferably 5 or more, and further preferably 20 or more. By adjusting the mixing ratio of an Si source and an Al source in a later-described starting material solution, or the like, it is possible to adjust the Si/Al ratio in the zeolite membrane 12. The zeolite membrane 12 may contain an alkali metal. The alkali metal is, for example, sodium (Na) or potassium (K).

From the viewpoint of an improvement in the separation performance, it is preferable that the maximum number of membered rings of the zeolite forming the zeolite membrane 12 should be 8. In other words, the zeolite is preferably an 8-membered ring zeolite. The zeolite membrane 12 is formed of, for example, DDR-type zeolite. In other words, the zeolite membrane 12 is a zeolite membrane formed of the zeolite having a structure code of “DDR” which is designated by the International Zeolite Association. In this case, the unique pore diameter of the zeolite forming the zeolite membrane 12 is 0.36 nm×0.44 nm, and the average pore diameter is 0.40 nm.

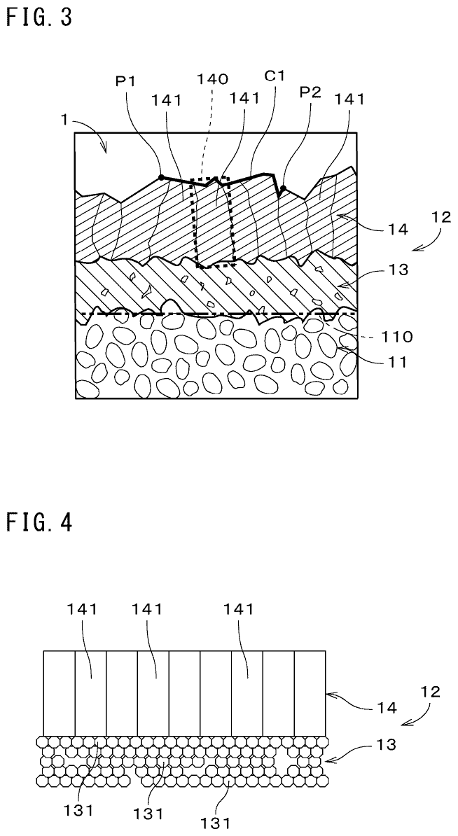

FIG. 3 is a view showing a cross section of the zeolite membrane complex 1, which is perpendicular to the surface of the support 11. FIG. 3 shows an image (i.e., TEM image) obtained by picking up an image of the vicinity of the zeolite membrane 12 in a sample produced for measurement, by a transmission electron microscope (TEM). In the following description, the image shown in FIG. 3 is simply referred to as a “cross sectional image”.

The zeolite membrane 12 includes a low density layer 13 and a dense layer 14. The low density layer 13 is in direct contact with the surface of the support 11 and covers the surface of the support 11. The dense layer 14 is in direct contact with a surface of the low density layer 13 and covers the surface of the low density layer 13. The dense layer 14 is not in direct contact with the surface of the support 11 and in indirect contact with the surface of the support 11 with the low density layer 13 interposed therebetween. The thickness of the dense layer 14 is, for example, larger than that of the low density layer 13. The thickness of the dense layer 14 may be not larger than that of the low density layer 13. Each of the low density layer 13 and the dense layer 14 contains zeolite crystals and grain boundaries. The grain boundary is a region between adjacent zeolite crystals. The grain boundary contains, for example, amorphia, crystals other than zeolite crystals and/or voids. Typically, the density of a grain boundary is lower than that of a zeolite crystal.

The content percentage of zeolite crystals 141 in the dense layer 14 is higher than the content percentage of zeolite crystals 131 (see FIG. 4 described later) in the low density layer 13. The content percentage of zeolite crystals 141 in the dense layer 14 is preferably not lower than 95%, and more preferably not lower than 96%. The content percentage of zeolite crystals 131 in the low density layer 13 is preferably not lower than 5% and lower than 95%, and more preferably not lower than 20% and not higher than 90%.

The content percentage of zeolite crystals 141 in the dense layer 14 is obtained by using the above-described cross sectional image. Specifically, in the cross sectional image, one arbitrary zeolite crystal 141 is selected, and a region including the grain boundaries between the selected zeolite crystal 141 and all adjacent zeolite crystals 141 is selected. Subsequently, the region is binarized by a predetermined threshold value. The threshold value is determined as appropriate so that the selected zeolite crystal 141 and the grain boundaries can be distinguished from each other. Next, on the basis of an image of the above-described binarized region, obtained are an area of a portion (e.g., the zeolite crystals 141) having an image density lower than the threshold value and an area of a portion (e.g., the grain boundaries) having an image density not lower than the threshold value. Then, the content percentage of zeolite crystals 141 in the region is obtained by dividing the area of the zeolite crystals 141 by a total area of the zeolite crystals 141 and the grain boundaries. In the present preferred embodiment, the respective content percentages of zeolite crystals 141 in ten regions in the dense layer 14 on the cross sectional image are obtained and an average of these content percentages is determined as the content percentage of the zeolite crystals 141 in the dense layer 14. The content percentage of zeolite crystals 131 in the low density layer 13 is also obtained by the same method as that for the dense layer 14.

In the exemplary case of FIG. 3, the dense layer 14 and the low density layer 13 each mainly contain one type of zeolite. In order to easily form the zeolite membrane 12, it is preferable that the type of zeolite contained in the dense layer 14 should be the same as the type of zeolite contained in the low density layer 13. The zeolite contained in each of the dense layer 14 and the low density layer 13 is preferably an 8-membered ring zeolite, and more preferably DDR-type zeolite. Further, the Si/Al ratio of zeolite contained in each of the dense layer 14 and the low density layer 13 is preferably 3 or more, more preferably 5 or more, and further preferably 20 or more. The type of zeolite contained in the dense layer 14 may be different from the type of zeolite contained in the low density layer 13.

FIG. 4 is a schematic diagram showing the dense layer 14 and the low density layer 13 in the zeolite membrane 12. As shown in FIG. 4, in the low density layer 13, a plurality of zeolite crystals 131 are layered in a thickness direction (an up-and-down direction in FIG. 4) of the zeolite membrane 12. In other words, the zeolite crystals 131 are layered in two or more layers, to thereby form the low density layer 13. On the other hand, in the dense layer 14, a plurality of zeolite crystals 141 each extending in the thickness direction are densely aligned along an interface between the dense layer 14 and the low density layer 13. In other words, almost one layer of zeolite crystals 141 forms the dense layer 14. Though FIG. 4 shows the plurality of zeolite crystals 131 contained in the low density layer 13, which have the same shape and size, the plurality of zeolite crystals 131 actually have various different shapes and sizes. Similarly, though FIG. 4 shows the plurality of zeolite crystals 141 contained in the dense layer 14, which have the same shape and size, the plurality of zeolite crystals 141 actually have various different shapes and sizes (see FIG. 3).

In the cross sectional image of FIG. 3, i.e., the cross section of the zeolite membrane complex 1 perpendicular to the surface of the support 11, the average aspect ratio of the zeolite crystals 141 contained in the dense layer 14 is preferably not smaller than 2 and not larger than 4, and more preferably not smaller than 2 and not larger than 3.8. It is thereby possible to achieve high water flux and high hydrothermal resistance, as described later. Further, the ratio of the number of zeolite crystals 141 each having an aspect ratio not smaller than 3 to the number of zeolite crystals 141 contained in the dense layer 14 is preferably not lower than 10%, and more preferably not lower than 20%. In the cross sectional image, the average inclination angle of zeolite crystals 141 in the longitudinal direction with respect to the surface of the support 11 is preferably not smaller than 60°, more preferably not smaller than 70°, and further preferably not smaller than 80°. It is thereby possible to suppress occurrence of a big clearance between crystals, which occurs when an inclination angle is small, and to achieve high separation performance. The average inclination angle is not larger than 90°.

The aspect ratio and the inclination angle of the zeolite crystals 141 contained in the dense layer 14 are obtained by using the above-described cross sectional image. Specifically, in the cross sectional image, one arbitrary zeolite crystal 141 is selected, and an approximate rectangle 140 which approximates an outer shape (contour) of the zeolite crystal 141 is set. The approximate rectangle 140 is, for example, a minimum bounding rectangle for the outer shape of the zeolite crystal 141. In FIG. 3, the approximate rectangle 140 of the zeolite crystal 141 is represented by a thick broken line. Further, in the cross sectional image, an approximate surface 110 of the support 11 is set. The approximate surface 110 is obtained by linear approximation of the surface of the support 11 in the cross sectional image by a least-squares method. In FIG. 3, the approximate surface 110 of the support 11 is represented by a two-dot chain line.

In the cross sectional image, an angle formed by a direction parallel to a long side of the approximate rectangle 140, i.e., a longitudinal direction of the approximate rectangle 140 and the approximate surface 110 of the support 11 is obtained as the inclination angle of the zeolite crystal 141. When the inclination angle of the zeolite crystal 141 is 45° or more, the aspect ratio of the zeolite crystal 141 is obtained by dividing the length of the long side of the approximate rectangle 140 by the length of a short side thereof. When the inclination angle of the zeolite crystal 141 is lower than 45°, the aspect ratio of the zeolite crystal 141 is obtained by dividing the length of the short side of the approximate rectangle 140 by the length of the long side thereof. In the preferred embodiment, as to 30 zeolite crystals 141 on the cross sectional image, the above-described aspect ratios and inclination angles are obtained, and an average of these aspect ratios is determined as the average aspect ratio of the zeolite crystals 141 and an average of these inclination angles is determined as the average inclination angle of the zeolite crystals 141. Further, the ratio of the zeolite crystals 141 each having an aspect ratio of 3 or more is also obtained from these aspect ratios.

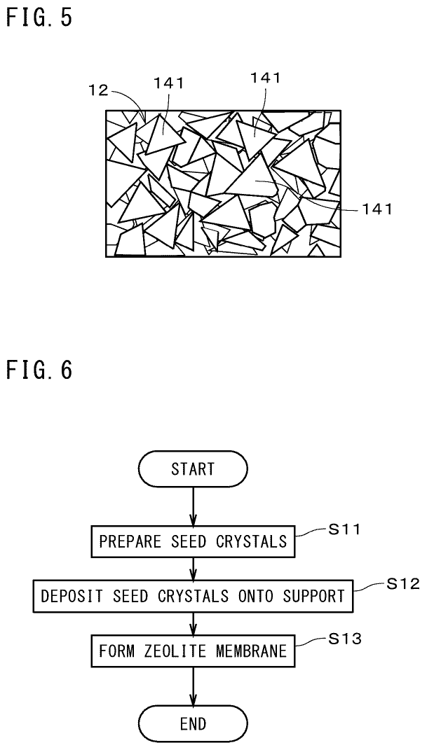

FIG. 5 is a view showing a surface of the zeolite membrane 12. FIG. 5 shows an image (i.e., SEM image) obtained by picking up an image of the surface of the zeolite membrane 12 which is a surface of the dense layer 14 from a direction perpendicular to the surface by a scanning electron microscope (SEM). In the following description, the image shown in FIG. 5 is simply referred to as a “surface image”.

As shown in FIG. 5, on the surface of the zeolite membrane 12, most of the zeolite crystals 141 each have a triangular shape. Among the zeolite crystals 141 positioned on the surface of the zeolite membrane 12, the ratio (hereinafter, simply referred to as a “ratio of crystals of triangular shape”) of the zeolite crystals 141 each having a triangular shape when observed from the direction perpendicular to the surface of the zeolite membrane 12 is not lower than 20%, preferably not lower than 30%, and more preferably not lower than 40%. As described later, high water flux is thereby achieved. The triangular shape is not limited to an exact triangle formed of only three sides (line segments), but may be a shape having rounded corners, a shape slightly chipped, a shape having slightly rounded sides, or the like. As described earlier, since the zeolite crystals 141 contained in the dense layer 14 each extend in the thickness direction, a side surface of the zeolite crystal 141 is reflected in the surface image depending on the inclination angle. In this case, a shape of a region except the region of the side surface is a shape of the zeolite crystal 141.

The ratio of the crystals of triangular shape in the surface image is obtained by using the above-described surface image. Specifically, in the surface image, 50 or more of zeolite crystals 141 whose shapes are checkable are selected, and it is determined whether or not the shape of each of the zeolite crystals 141 is a triangular shape. Then, the ratio of the number of zeolite crystals 141 whose shapes are each determined as a triangular shape to all the zeolite crystals 141 whose shapes are determined is determined as the ratio of the crystals of triangular shape.

In the zeolite membrane 12 in which most of the zeolite crystals 141 contained in the dense layer 14 each have a triangular shape, projections and depressions occur in the surface thereof. The projections and depressions in the surface of the zeolite membrane 12 can be quantified by using the cross sectional image in FIG. 3. Specifically, in the cross sectional image, two points P1 and P2 separated away from each other (e.g., by 1 to 5 μm) on the surface of the zeolite membrane 12 are arbitrarily determined. Subsequently, the length of a ridgeline C1 on the surface of the zeolite membrane 12 between the two points P1 and P2 and the distance (minimum distance) between the points P1 and P2 are obtained. In FIG. 3, the ridgeline C1 on the surface of the zeolite membrane 12 is represented by a thick solid line. In the zeolite membrane complex 1, a value obtained by dividing the length of the ridgeline C1 between the two points P1 and P2 by the distance between the two points P1 and P2 is preferably 1.2 or more, and more preferably 1.3 or more. An upper limit of this value is not particularly limited but is, for example, 2.0.

Next, with reference to FIG. 6, an exemplary flow of manufacturing the zeolite membrane complex 1 will be described. In manufacturing the zeolite membrane complex 1, first, membrane-forming seed crystals to be used for manufacturing the zeolite membrane 12 are prepared (Step S11). For example, DDR-type zeolite powder is synthesized by hydrothermal synthesis, and the membrane-forming seed crystals are acquired from the zeolite powder. The DDR-type zeolite powder is synthesized by a manufacturing method disclosed in Japanese Patent Application Laid Open Gazette No. 2004-83375 (above-described Document 3), which is incorporated herein by reference. In the manufacturing method, after the DDR-type zeolite powder as seed crystals is added and dispersed in a starting material solution having a predetermined composition, containing 1-adamantanamine dissolved in ethylenediamine, heat treatment of the starting material solution is performed. At that time, by setting the heating temperature of the starting material solution to be, for example, 150 to 180° C., membrane-forming seed crystals each having a preferable crystal shape are obtained. The shape of the membrane-forming seed crystal is preferably a rhombohedral shape or an octahedral shape. The heating time of the starting material solution is, for example, 1 to 5 days.

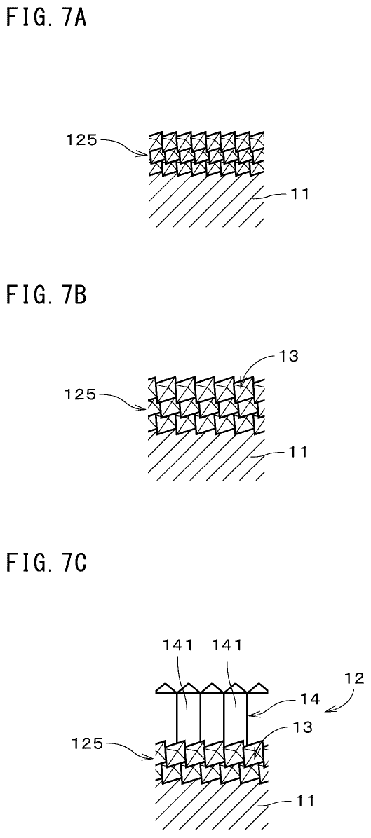

Subsequently, the membrane-forming seed crystals are deposited on the support 11 (Step S12). FIGS. 7A to 7C are views each used for explaining formation of the zeolite membrane 12 and each schematically showing the membrane-forming seed crystals and the like on the support 11. In Step S12, as shown in FIG. 7A, formed is a seed crystal layered body 125 in which two or more layers of the membrane-forming seed crystals are layered on the surface of the support 11. The seed crystal layered body 125 has a plurality of seed crystal layers which are layered on one another. It is preferable that the thickness of the seed crystal layered body 125 should be substantially uniform.

Formation of the seed crystal layered body 125 in Step S12 is performed, for example, by immersing the porous support 11 in a solution in which the membrane-forming seed crystals are dispersed. In this case, in order to form the seed crystal layered body 125 on the support 11, immersion and dry of the support 11 may be repeated a plurality of times. Formation of the seed crystal layered body 125 on the support 11 may be performed by bringing the solution in which the membrane-forming seed crystals are dispersed into contact with the surface of the support 11. Further, the seed crystal layered body 125 may be formed on the support 11 by any other method.

The support 11 on which the seed crystal layered body 125 is deposited is immersed in the starting material solution. The starting material solution is produced by dissolving, for example, Si source (silica source), Al source (alumina source), structure-directing agent (SDA), and the like in a solvent. The composition of the starting material solution is, for example, 1.00 SiO₂: 0.01 Al₂O₃: 0.015 SDA: 100 H₂O. The Si source is, for example, colloidal silica, fumed silica, tetraethoxysilane, sodium silicate, or the like. The Al source is, for example, sodium aluminate, aluminum isopropoxide, aluminum hydroxide, boehmite, sodium aluminate, alumina sol, or the like. The SDA is, for example, an organic substance. As the SDA, for example, used is 1-adamantanamine. As the solvent of the starting material solution, alcohol (e.g., ethanol) or the like, as well as water, may be used. When water is used as the solvent of the starting material solution, the molar ratio of the SDA to water contained in the starting material solution is preferably 0.01 or less. Further, the molar ratio of the SDA to water contained in the starting material solution is preferably 0.00001 or more.

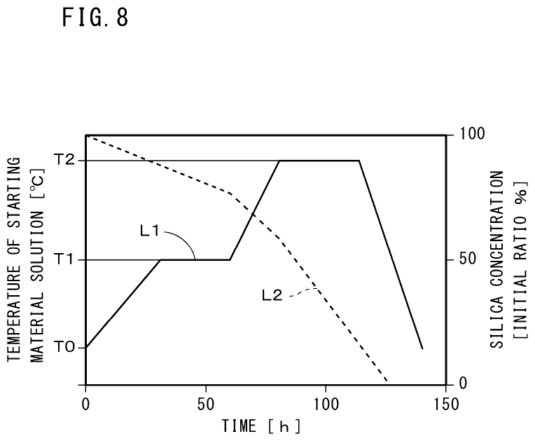

After that, the DDR-type zeolite is caused to grow from the seed crystals of the above-described seed crystal layered body 125 as nuclei by the hydrothermal synthesis, to thereby form the DDR-type zeolite membrane 12 on the support 11 (Step S13). FIG. 8 is a graph showing a change in the temperature of the starting material solution during the hydrothermal synthesis. In FIG. 8, the change in the temperature of the starting material solution is represented by a solid line L1 and a change in the silica concentration in the starting material solution is represented by a broken line L2. The silica concentration is indicated by the initial ratio, and the silica concentration at the start of the hydrothermal synthesis is assumed to be 100%.

As shown in FIG. 8, in the hydrothermal synthesis, the starting material solution is heated in two stages. In the present exemplary process, the starting material solution is heated from an initial temperature T0 (for example, a room temperature) to a first synthesis temperature T1 and then maintained to be constant at the first synthesis temperature T1. When a predetermined time elapses from reaching the first synthesis temperature T1, the starting material solution is heated from the first synthesis temperature T1 to a second synthesis temperature T2 higher than the first synthesis temperature T1 and then maintained to be constant at the second synthesis temperature T2. When a predetermined time elapses from reaching the second synthesis temperature T2, the temperature of the starting material solution is returned to the vicinity of the initial temperature T0.

In the period while the starting material solution is maintained at the relatively low first synthesis temperature T1, the silica concentration is relatively high and zeolites grow in various directions from the seed crystals of the seed crystal layered body 125. As shown in FIG. 7B, the low density layer 13 is thereby formed. In the period while the starting material solution is maintained at the relatively high second synthesis temperature T2, the silica concentration is relatively low and zeolites grow in the thickness direction from the zeolite crystals contained in the low density layer 13. As shown in FIG. 7C, the dense layer 14 is thereby formed. As described earlier, in the dense layer 14, a plurality of zeolite crystals 141 each extending in the thickness direction are densely aligned along the surface of the low density layer 13.

As can be seen from FIG. 8, in the hydrothermal synthesis, by changing the first synthesis temperature T1 and the time for maintaining the first synthesis temperature T1, it is possible to adjust the silica concentration (the amount of Si) in the starting material solution at the synthesis at the second synthesis temperature T2. Actually, with the silica concentration in the starting material solution at the synthesis at the second synthesis temperature T2 and the like, it is possible to adjust the average aspect ratio of the zeolite crystals 141 contained in the dense layer 14.

The first synthesis temperature T1 is, for example, 100° C. to 130° C., and preferably 110° C. to 120° C. The second synthesis temperature T2 is, for example, 130° C. to 160° C., and preferably 140° C. to 150° C. The time for maintaining the first synthesis temperature T1 is, for example, 10 to 20 hours, and preferably 10 to 15 hours. The time for maintaining the second synthesis temperature T2 is, for example, 20 to 30 hours, and preferably 25 to 30 hours. Total time for maintaining the first synthesis temperature T1 and the second synthesis temperature T2 is preferably 4 to 100 hours, and for example, 40 hours. In the synthesis of the zeolite membrane 12, it is not always necessary to set a period for maintaining the starting material solution at a constant temperature, but for example, by temporarily slowing the temperature change rate at heating, formation of the low density layer 13 and formation of the dense layer 14 may be achieved.

After the hydrothermal synthesis is finished, the support 11 and the zeolite membrane 12 are washed with pure water. The support 11 and the zeolite membrane 12 after being washed are dried at, for example, 80° C. After drying the support 11 and the zeolite membrane 12, the heat treatment is performed on the zeolite membrane 12, to thereby almost completely burn and remove the SDA in the zeolite membrane 12 and allow micropores in the zeolite membrane 12 to penetrate the zeolite membrane 12. The above-described zeolite membrane complex 1 is thereby obtained.

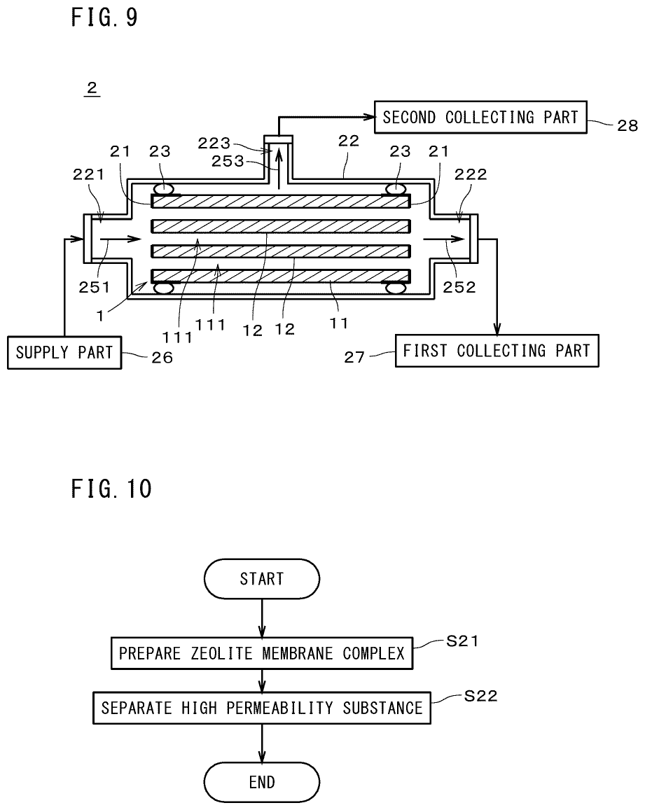

Next, with reference to FIGS. 9 and 10, separation of a mixed substance by using the zeolite membrane complex 1 will be described. FIG. 9 is a view showing a separation apparatus 2. FIG. 10 is a flowchart showing a flow of separating the mixed substance, performed by the separation apparatus 2.

In the separation apparatus 2, a mixed substance containing a plurality of types of fluids (i.e., gases or liquids) is supplied to the zeolite membrane complex 1, and a substance with high permeability (hereinafter, referred to also as a “high permeability substance”) in the mixed substance is caused to permeate the zeolite membrane complex 1, to be thereby separated from the mixed substance. Separation in the separation apparatus 2 may be performed, for example, in order to extract a high permeability substance from a mixed substance, or in order to concentrate a substance with low permeability (hereinafter, referred to also as a “low permeability substance”).

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one type of, for example, hydrogen (H₂), helium (He), nitrogen (N₂), oxygen (O₂), water (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde. The above-described high permeability substance is at least one type of, for example, H₂, He, N₂, O₂, CO₂, NH₃, and H₂O, and preferably H₂O.

The nitrogen oxide is a compound of nitrogen and oxygen. The above-described nitrogen oxide is, for example, a gas called NO_{X} such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SO_{X} such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH(CH₃)₃), 1-butene (CH₂═CHCH₂CH₃), 2-butene (CH₃CH═CHCH₃), or isobutene (CH₂═C(CH₃).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), tetrahydrofuran ((CH₂)₄O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the mixed substance to be separated by the separation apparatus 2 is a mixed liquid containing a plurality of types of liquids and separation is performed by a pervaporation method.

The separation apparatus 2 includes the zeolite membrane complex 1, sealing parts 21, a housing 22, two sealing members 23, a supply part 26, a first collecting part 27, and a second collecting part 28. The zeolite membrane complex 1, the sealing parts 21, and the sealing members 23 are accommodated inside the housing 22. The supply part 26, the first collecting part 27, and the second collecting part 28 are disposed outside the housing 22 and connected to the housing 22.

The sealing parts 21 are members which are attached to both end portions in the longitudinal direction (i.e., in the left and right direction of FIG. 9) of the support 11 and cover and seal both end surfaces in the longitudinal direction of the support 11 and outer surfaces in the vicinity of the end surfaces. The sealing parts 21 prevent a liquid from flowing into or out from both the end surfaces of the support 11. The sealing part 21 is, for example, a plate-like member formed of glass or a resin. The material and the shape of the sealing part 21 may be changed as appropriate. Further, since the sealing part 21 is provided with a plurality of openings which coincide with the plurality of through holes 111 of the support 11, both ends of each through hole 111 of the support 11 in the longitudinal direction are not covered with the sealing parts 21. Therefore, the liquid or the like can flow into and out from the through hole 111 from both ends thereof.

There is no particular limitation on the shape of the housing 22 but is, for example, a tubular member having a substantially cylindrical shape. The housing 22 is formed of, for example, stainless steel or carbon steel. The longitudinal direction of the housing 22 is substantially in parallel to the longitudinal direction of the zeolite membrane complex 1. A supply port 221 is provided at an end portion on one side in the longitudinal direction of the housing 22 (i.e., an end portion on the left side in FIG. 9), and a first exhaust port 222 is provided at another end portion on the other side. A second exhaust port 223 is provided on a side surface of the housing 22. The supply part 26 is connected to the supply port 221. The first collecting part 27 is connected to the first exhaust port 222. The second collecting part 28 is connected to the second exhaust port 223. An internal space of the housing 22 is a sealed space that is isolated from the space around the housing 22.

The two sealing members 23 are arranged around the entire circumference between an outer surface of the zeolite membrane complex 1 and an inner surface of the housing 22 in the vicinity of both end portions of the zeolite membrane complex 1 in the longitudinal direction. Each of the sealing members 23 is a substantially annular member formed of a material that the liquid cannot permeate. The sealing member 23 is, for example, an O-ring formed of a flexible resin. The sealing members 23 come into close contact with the outer surface of the zeolite membrane complex 1 and the inner surface of the housing 22 around the entire circumferences thereof. In the exemplary case of FIG. 9, the sealing members 23 come into close contact with outer surfaces of the sealing parts 21 and indirectly come into close contact with the outer surface of the zeolite membrane complex 1 with the sealing parts 21 interposed therebetween. The portions between the sealing members 23 and the outer surface of the zeolite membrane complex 1 and between the sealing members 23 and the inner surface of the housing 22 are sealed, and it is thereby mostly or completely impossible for the liquid to pass through the portions.

The supply part 26 supplies the mixed liquid into the internal space of the housing 22 through the supply port 221. The supply part 26 includes, for example, a pump for pumping the mixed liquid toward the housing 22. The pump includes a temperature regulating part and a pressure regulating part which regulate the temperature and the pressure of the mixed liquid, respectively, to be supplied to the housing 22. The first collecting part 27 includes, for example, a storage container for storing the liquid led out from the housing 22 or a pump for transporting the liquid. The second collecting part 28 includes, for example, a vacuum pump for decompressing a space outside the outer surface of the zeolite membrane complex 1 inside the housing 22 (in other words, a space sandwiched between the two sealing members 23) and a cooling chiller trap for cooling and liquefying the gas permeating the zeolite membrane complex 1 while vaporizing.

When separation of the mixed liquid is performed, the above-described separation apparatus 2 is prepared and the zeolite membrane complex 1 is thereby prepared (FIG. 10: Step S21). Subsequently, the supply part 26 supplies a mixed liquid containing a plurality of types of liquids with different permeabilities to the zeolite membrane 12 into the internal space of the housing 22. For example, the main component of the mixed liquid includes water (H₂O) and ethanol (C₂H₅OH). The mixed liquid may contain any liquid other than water and ethanol. The pressure (i.e., feed pressure) of the mixed liquid to be supplied into the internal space of the housing 22 from the supply part 26 is, for example, 0.1 MPa to 2 MPa. The temperature of the mixed liquid is, for example, 10° C. to 200° C.

The mixed liquid supplied from the supply part 26 into the housing 22 is fed from the left end of the zeolite membrane complex 1 in this figure into the inside of each through hole 111 of the support 11 as indicated by an arrow 251. A high permeability substance which is a liquid with high permeability in the mixed liquid permeates the zeolite membrane 12 provided on the inner surface of each through hole 111 and the support 11 while vaporizing, and is led out from the outer surface of the support 11. The high permeability substance (for example, water) is thereby separated from a low permeability substance which is a liquid with low permeability (for example, ethanol) in the mixed liquid (Step S22).

The gas (hereinafter, referred to as a “permeate substance”) led out from the outer surface of the support 11 is guided to the second collecting part 28 through the second exhaust port 223 as indicated by an arrow 253 and cooled and collected by the second collecting part 28 as a liquid. The pressure (i.e., permeate pressure) of the gas to be collected by the second collecting part 28 through the second exhaust port 223 is, for example, about 6.67 kPa (about 50 Torr). In the permeate substance, the low permeability substance permeating the zeolite membrane 12 may be included as well as the above-described high permeability substance.

Further, in the mixed liquid, a liquid (hereinafter, referred to as a “non-permeate substance”) other than the substance which has permeated the zeolite membrane 12 and the support 11 passes through each through hole 111 of the support 11 from the left side to the right side in this figure and is collected by the first collecting part 27 through the first exhaust port 222 as indicated by an arrow 252. The pressure of the liquid to be collected by the first collecting part 27 through the first exhaust port 222 is, for example, substantially the same as the feed pressure. The non-permeate substance may include a high permeability substance that has not permeated the zeolite membrane 12, as well as the above-described low permeability substance. The non-permeate substance collected by the first collecting part 27 may be, for example, circulated to the supply part 26 and supplied again into the housing 22.

Next, with reference to Table 1, Examples 1 to 3 and Comparative Examples 1 to 5 of the zeolite membrane complex will be described.

TABLE 1

| | | | | | | | Ratio of | | |
|---|---|---|---|---|---|---|---|---|---|
| | | Shape of | Seed | | Structure of | Average | Crystals of | | Hydro- |
| | | Seed | Crystal | Synthesis | Zeolite | Aspect | Triangular | Waterx | thermal |
| | Overview | Crystal | Layer | Conditions | Membrane | Ratio | Shape | Flux | Resistance |
| Example 1 | Aspect Ratio | Rhombo- | Composite | Low | Dense Layer | 3.8 | 20% or | ⊚ | ◯ |
| | is Large | hedral | Layer | Temperature: | Low Density | | More | | |
| | | | | 10 Hours | Layer | | | | |
| | | | | High | | | | | |
| | | | | Temperature: | | | | | |
| | | | | 30 Hours | | | | | |
| Example 2 | Aspect Ratio | Rhombo- | Composite | Low | Dense Layer | 3 | 20% or | ◯ | ◯ |
| | is Middle | hedral | Layer | Temperature: | Low Density | | More | | |
| | | | | 15 Hours | Layer | | | | |
| | | | | High | | | | | |
| | | | | Temperature: | | | | | |
| | | | | 28 Hours | | | | | |
| Example 3 | Aspect Ratio | Rhombo- | Composite | Low | Dense Layer | 2 | 20% or | Δ | ◯ |
| | is Small | hedral | Layer | Temperature: | Low Density | | More | | |
| | | | | 20 Hours | Layer | | | | |
| | | | | High | | | | | |
| | | | | Temperature: | | | | | |
| | | | | 25 Hours | | | | | |
| Comparative | Shape of | Spherical | Composite | Low | Dense Layer | — | Lower | X | — |
| Example 1 | Seed Crystal | | Layer | Temperature: | Low Density | | Than 5% | | |
| | is Spherical | | | 20 Hours | Layer | | | | |
| | | | | High | | | | | |
| | | | | Temperature: | | | | | |
| | | | | 25 Hours | | | | | |
| Comparative | Aspect Ratio | Rhombo- | Composite | Low | Dense Layer | 1.5 | 20% or | X | — |
| Example 2 | is Excessively | hedral | Layer | Temperature: | Low Density | | More | | |
| | Small | | | 20 Hours | Layer | | | | |
| | | | | High | | | | | |
| | | | | Temperature: | | | | | |
| | | | | 15 Hours | | | | | |
| Comparative | Aspect Ratio | Rhombo- | Composite | Low | Dense Layer | 5 | 20% or | ⊚ | X |
| Example 3 | is Excessively | hedral | Layer | Temperature: | Low Density | | More | | |
| | Large | | | 5 Hours | Layer | | | | |
| | | | | High | | | | | |
| | | | | Temperature: | | | | | |
| | | | | 35 Hours | | | | | |
| Comparative | Seed Crystal | Rhombo- | Single | High | Dense Layer | — | 20% or | X | — |
| Example 4 | Layer is | hedral | Layer | Temperature: | | | More | | |
| | Single | | | 36 Hours | | | | | |
| Comparative | No Temperature | Rhombo- | Composite | High | Dense Layer | — | Lower | X | — |
| Example 5 | Change in | hedral | Layer | Temperature: | Low Density | | Than 10% | | |
| | Synthesis | | | 34 Hours | Layer | | | | |
| | Conditions | | | | | | | | |

### (Production of Seed Crystals)

Like in the manufacturing method disclosed in Japanese Patent Application Laid Open Gazette No. 2004-83375 (above-described Document 3), the seed crystals are added to and dispersed in the starting material solution, and then the heat treatment is performed on the starting material solution. The membrane-forming seed crystals which are the DDR-type zeolite crystal powder are thereby produced. At that time, in Examples 1 to 3 and Comparative Examples 2 to 5, the heating temperature of the starting material solution is 150° C. and the synthesis is performed for 3 days, to thereby obtain the membrane-forming seed crystals each having a rhombohedral shape. In Comparative Example 1, the heating temperature of the starting material solution is 120° C. and the synthesis is performed for 3 days, to thereby obtain the membrane-forming seed crystals each having a spherical shape.

### (Deposition of Seed Crystals)

A support is brought into contact with a solution in which the membrane-forming seed crystals are dispersed and the seed crystals are thereby deposited onto the support. At that time, in Examples 1 to 3 and Comparative Examples 1 to 3 and 5, as described with reference to FIG. 7A, a seed crystal layered body (i.e., a composite layer) in which two or more layers of the membrane-forming seed crystals are layered is formed. In Comparative Example 4, a seed crystal single layer body having one layer of the membrane-forming seed crystals is formed.

### (Synthesis of DDR-Type Zeolite)

The support on which the seed crystals are deposited is immersed in the starting material solution (synthetic sol) contained in a sealed container. The starting material solution is produced by dissolving the Si source, the Al source, the SDA, and the like in a solvent. The composition of the starting material solution is 1.00 SiO₂: 0.01 Al₂O₃: 0.015 SDA: 100 H₂O. As the SDA contained in the starting material solution, 1-adamantanamine is used. Then, the DDR-type zeolite is caused to grow from the seed crystals as nuclei by the hydrothermal synthesis, to thereby form the DDR-type zeolite membrane on the support. In the hydrothermal synthesis, as described with reference to FIG. 8, the starting material solution is heated in two stages. The first synthesis temperature T1 is 100° C. and the second synthesis temperature T2 is 140° C. The time for maintaining the first synthesis temperature T1 in Examples 1 to 3 and Comparative Examples 1 to 3 is time indicated with “low temperature” in Table 1, and the time for maintaining the second synthesis temperature T2 is time indicated with “high temperature” in Table 1. In Comparative Examples 4 and 5, the starting material solution is heated at 140° C. in one stage.

### (Washing of DDR-Type Zeolite and Removal of SDA)

After the hydrothermal synthesis, the support and the zeolite membrane are sufficiently washed with pure water and then dried at 80° C. After that, a heat treatment is performed on the zeolite membrane, to thereby burn and remove the SDA. Through the above-described process, a zeolite membrane complex having the DDR-type zeolite membrane in each of Examples 1 to 3 and Comparative Examples 1 to 5 is obtained.

### (Measurement of Average Aspect Ratio)

A sample for measurement prepared from the zeolite membrane complex is observed by the transmission electron microscope (TEM), to thereby obtain a cross sectional image. In the zeolite membrane complex in each of Examples 1 to 3 and Comparative Examples 1 to 3 and 5, the existence of a low density layer and a dense layer is recognized. Further, the thicknesses of the zeolite membranes including the low density layer and the dense layer are almost the same. On the other hand, in Comparative Example 4, the low density layer is not present and only the dense layer is recognized.

In the cross sectional image, one arbitrary zeolite crystal contained in the dense layer is selected, and an approximate rectangle which is the minimum bounding rectangle with respect to an outer shape of the zeolite crystal is set. When an inclination angle of the longitudinal direction of the approximate rectangle with respect to an approximate surface of the support is not smaller than 45°, a value obtained by dividing the length of a long side of the approximate rectangle by the length of a short side thereof is determined as the aspect ratio of the zeolite crystal. When the inclination angle is smaller than 45°, a value obtained by dividing the length of the short side of the approximate rectangle by the length of the long side thereof is determined as the aspect ratio of the zeolite crystal. The above-described respective aspect ratios are obtained on 30 zeolite crystals on the cross sectional image, and an average of these aspect ratios is determined as an average aspect ratio of the zeolite crystals contained in the dense layer.

As shown in Table 1, in the zeolite membrane complex of each of Examples 1 to 3, the average aspect ratio of the zeolite crystals contained in the dense layer is not smaller than 2 and not larger than 4. On the other hand, in Comparative Example 2, the average aspect ratio is smaller than 2, and in Comparative Example 3, the average aspect ratio is larger than 4. Further, in Examples 1 to 3, the ratio of the zeolite crystals each having an aspect ratio not smaller than 3 to the zeolite crystals contained in the dense layer is not lower than 10%, and the average inclination angle is not smaller than 60° and not larger than 90°. In Comparative Examples 1, 4, and 5, the measurement of the aspect ratio is omitted.

### (Ratio of Crystals of Triangular Shape)

A surface of the zeolite membrane which is a surface of the dense layer is observed from a direction perpendicular to the surface by the scanning electron microscope (SEM), and a surface image is thereby obtained. In the surface image, 50 or more zeolite crystals are selected, and the ratio of the number of zeolite crystals each having a triangular shape to the number of these zeolite crystals is obtained as a ratio of crystals of triangular shape. In the zeolite membrane complex of each of Examples 1 to 3 and Comparative Examples 2 to 4, the ratio of crystals of triangular shape is 20% or more. On the other hand, in Comparative Example 1 using the membrane-forming seed crystals each having a spherical shape, the ratio of crystals of triangular shape is 5% or less. Further, in Comparative Example 5, the ratio of crystals of triangular shape is 10% or less. In Comparative Example 5, like in Examples 1 to 3, though the membrane-forming seed crystals each having a rhombohedral shape are used, since the starting material solution is heated only in one stage at the second synthesis temperature T2 (high temperature), it can be thought that crystal growth of the membrane rapidly occurs and the crystal shape does not become a triangular shape.

### (Evaluation of Membrane Performance)

By using the above-described separation apparatus 2, water and ethanol (=50:50 (mass ratio)) are separated from each other by the pervaporation method at the temperature of 60° C. and the permeate-side pressure of 50 torr, and the permeance of the liquid collected by the second collecting part 28 is measured. The density of the liquid is obtained by a density hydrometer and the quantity ratio of water and ethanol is measured. Then, the water flux and the separation factor are obtained from the permeance of the liquid and the quantity ratio of water and ethanol. The separation factor is a value obtained by dividing the water concentration (mass %) by the ethanol concentration. In Table 1, when the water flux is not lower than 2.5 kg/m²h, the evaluation is “⊚ (double circle)”, and when the water flux is lower than 2.5 kg/m²h and not lower than 2.0 kg/m²h, the evaluation is “∘ (circle)”. Further, when the water flux is lower than 2.0 kg/m²h and not lower than 1.5 kg/m²h, the evaluation is “Δ (triangle)”, and when the water flux is lower than 1.5 kg/m²h, the evaluation is “x (cross)”. In the zeolite membrane complex of each of Examples 1 to 3 and Comparative Example 3, the water flux is not lower than 1.5 kg/m²h, and thus high water flux is achieved. In Comparative Examples 1, 2, 4, and 5, the water flux is lower than 1.5 kg/m²h.

### (Evaluation of Hydrothermal Resistance)

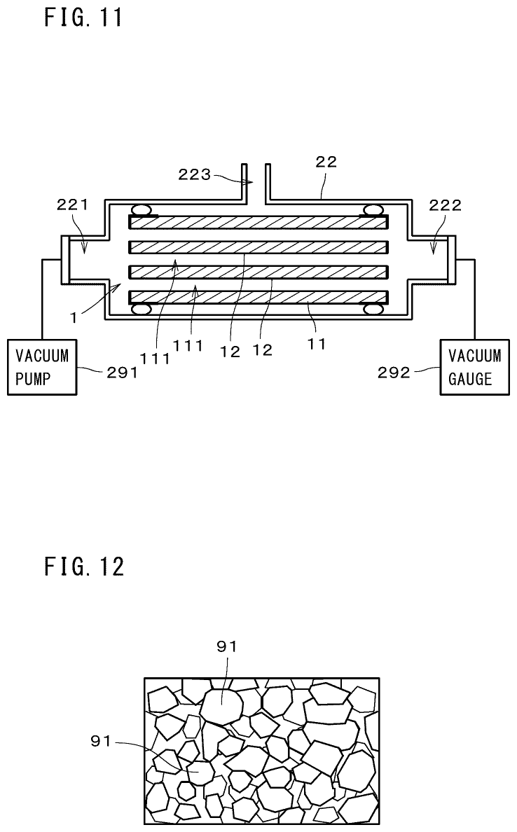

In the evaluation of the hydrothermal resistance, like in FIG. 9, the degree of vacuum is measured by using the housing 22 in which the zeolite membrane complex 1 is accommodated. In the measurement of the degree of vacuum, as shown in FIG. 11, a vacuum pump 291 (Direct Drive Oil-Sealed Rotary Vacuum Pump made by ULVAC KIKO, Inc., the model number: G-20DA, the pumping speed: 24 L/min, the ultimate pressure: 1.3 Pa, two-stage type) is connected to the port 221 that is one end portion of the housing 22 in the longitudinal direction and the housing 22 is evacuated. Further, a vacuum gauge 292 (Calibrator made by GE Sensing, the model number: DP1800) is connected to the port 222 that is the other end portion of the housing 22 and the ultimate degree of vacuum is measured. At that time, the port 223 provided in aside surface of the housing 22 is open to atmosphere. Subsequently, the zeolite membrane complex taken out from the housing 22 is immersed in high-temperature water (180° C.) for 12 hours and then washed by ion exchange water and dried at room temperature for 12 or more hours. After that, the degree of vacuum is measured again and the ratio of the degree of vacuum after the immersion to the degree of vacuum before the immersion is determined as an index of the hydrothermal resistance. In Table 1, when the ratio is not lower than 95%, the evaluation is “∘ (circle)”, when the ratio is lower than 95% and not lower than 90%, the evaluation is “Δ (triangle)”, and when the ratio is lower than 90%, the evaluation is “x (cross)”. In the zeolite membrane complex of each of Examples 1 to 3, the ratio is not lower than 95%, and thus high hydrothermal resistance is achieved. In Comparative Example 3, the ratio is lower than 90%, the hydrothermal resistance is low. Further, in Comparative Examples 1, 2, 4, and 5 where the water flux is low, the evaluation of the hydrothermal resistance is not performed.

Herein, in the zeolite membrane complex of each of Examples 1 to 3, examined is the reason why the water flux and the hydrothermal resistance are higher than those in Comparative Examples 1 to 5. FIG. 12 is a view showing the surface of the zeolite membrane in the zeolite membrane complex of Comparative Example 1, which corresponds to the surface image of FIG. 5.

As shown in FIG. 12, in the zeolite membrane complex of Comparative Example 1, most of zeolite crystals 91 each have a substantially circular shape. Those in the zeolite membrane complex of Comparative Example 5 are the same as in Comparative Example 1. On the other hand, in the zeolite membrane complex of each of Examples 1 to 3, as shown in FIG. 5, most of the zeolite crystals 141 each have a triangular shape. As compared between the zeolite crystal 91 shown in FIG. 12 and the zeolite crystal 141 shown in FIG. 5 which have the same area, the zeolite crystal 141 having a triangular shape have a length of circumference longer than that of the zeolite crystal 91 having a substantially circular shape. In the zeolite membrane complex of each of Examples 1 to 3, it can be thought that the permeance of water passing through the grain boundaries is higher than that in Comparative Examples 1 and 5, and the water flux in Examples 1 to 3 becomes higher.

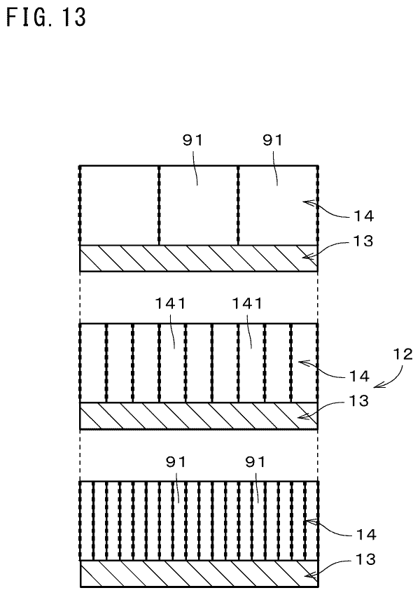

FIG. 13 is a schematic diagram showing the zeolite crystals contained in the dense layer 14. The upper stage of FIG. 13 shows the zeolite crystals 91 having an average aspect ratio of 1 in Comparative Examples, the middle stage shows the zeolite crystals 141 having an average aspect ratio of 3, and the lower stage shows the zeolite crystals 91 having an average aspect ratio of 6 in Comparative Examples. The respective dense layers 14 in the upper, middle, and lower stages of FIG. 13 have the same thickness.

As shown in the upper stage of FIG. 13, when the average aspect ratio of the zeolite crystals 91 is excessively small, the number of grain boundaries (indicated by a thick broken line in FIG. 13) per unit area is smaller than that in the middle stage of FIG. 13. Therefore, in the zeolite membrane complex of Comparative Example 2, where the average aspect ratio is excessively small, it is thought that the water flux is reduced. As shown in the lower stage of FIG. 13, where the average aspect ratio of the zeolite crystals 91 is excessively large, the number of grain boundaries per unit area is larger than that in the middle stage of FIG. 13. Therefore, in the zeolite membrane complex of Comparative Example 3, where the average aspect ratio is excessively large, it is thought that the water flux increases but the hydrothermal resistance is reduced since the grain boundaries are easily damaged. In other words, in the zeolite membrane complex of each of Examples 1 and 3, where the average aspect ratio is not smaller than 2 and not larger than 4, both the water flux and the hydrothermal resistance increase. Further, in Comparative Example 4 where only the dense layer is formed, it is thought that the length of the grain boundary that water permeates becomes excessively longer and the water flux becomes lower.

As described above, the zeolite membrane complex 1 includes the porous support 11 and the zeolite membrane 12 formed on the support 11. The zeolite membrane 12 includes the low density layer 13 covering the support 11 and the dense layer 14 covering the low density layer 13. In a cross section of the zeolite membrane complex 1 perpendicular to the surface of the support 11, the average aspect ratio of the zeolite crystals 141 contained in the dense layer 14 is not smaller than 2 and not larger than 4. Further, when the surface of the zeolite membrane 12 which is the surface of the dense layer 14 is observed from a direction perpendicular to the surface, 20% or more of zeolite crystals 141 among the zeolite crystals 141 positioned on the surface each have a triangular shape. As shown in above-described Examples 1 and 3, it is thereby possible to achieve the zeolite membrane complex 1 having high water flux and the hydrothermal resistance. Furthermore, on the low density layer 13 covering the support 11, the dense layer 14 having a content percentage of zeolite crystals higher than that in the low density layer 13 is formed, and thus it is possible to more easily form the thin dense layer 14 having no defect, as compared with a case where the dense layer 14 is formed directly on the support. As a result, both high water flux and high separation performance can be achieved.

Preferably, in the above-described cross section of the zeolite membrane complex 1, the ratio of the zeolite crystals 141 each having an aspect ratio of 3 or more, among the zeolite crystals 141 contained in the dense layer 14, is not lower than 10%. Thus, by containing more zeolite crystals 141 having an aspect ratio within a preferable range, it becomes possible to reliably improve the water flux and the hydrothermal resistance.

Preferably, in the above-described cross section of the zeolite membrane complex 1, the average inclination angle of the zeolite crystals 141 contained in the dense layer 14 in the longitudinal direction with respect to the surface of the support 11 is not smaller than 60° and not larger than 90° Thus, in the zeolite membrane complex 1 having a large average inclination angle, it is possible to suppress occurrence of a big clearance between crystals and to achieve high separation performance.

Preferably, in the above-described cross section of the zeolite membrane complex 1, the length of the ridgeline C1 on the surface of the zeolite membrane 12 between the two points P1 and P2 separated from each other on the surface thereof is 1.2 times or more as long as the distance between the two points P1 and P2. In such a zeolite membrane 12, since the zeolite crystals 141 each having a preferable shape are formed in the dense layer 14, it is possible to more reliably achieve high water flux and high hydrothermal resistance.

Preferably, the Si/Al ratio of the zeolite contained in the dense layer 14 is 3 or more. It is thereby possible to further improve the hydrothermal resistance in the zeolite membrane complex 1. Further, it is preferable that the zeolite contained in the dense layer 14 should be an 8-membered ring zeolite. It is thereby possible to suitably achieve selective permeation of a target substance to be permeated (especially, water) having a relatively small molecular diameter in the zeolite membrane complex 1.

The above-described separation method includes a step of preparing the zeolite membrane complex 1 (Step S21) and a step of supplying the mixed substance containing a plurality of types of gases or liquids to the zeolite membrane complex 1 and causing the substance with high permeability in the mixed substance to permeate the zeolite membrane complex 1, to be separated from any other substance (Step S22). In the separation method, by using the zeolite membrane complex 1 having high water flux and high hydrothermal resistance, it is possible to efficiently and stably perform separation of various mixed substances. The separation method using the zeolite membrane complex 1 is especially suitable for separation of the mixed substance including water.

In the zeolite membrane complex 1 and the separation method described above, various modifications can be made.

In the cross sectional image of FIG. 3, the ratio of the zeolite crystals 141 each having an aspect ratio of 3 or more, among the zeolite crystals 141 contained in the dense layer 14, may be lower than 10%. Further, the average inclination angle of the zeolite crystals 141 may be smaller than 60°. Furthermore, a value obtained by dividing the length of the ridgeline C1 between the two points P1 and P2 on the surface of the zeolite membrane 12 by the distance between the two points P1 and P2 may be smaller than 1.2.

The Si/Al ratio of the zeolite contained in the dense layer 14 may be smaller than 3, and the maximum number of membered rings of the zeolite may be smaller than 8 or larger than 8.

The zeolite membrane complex 1 may further include a function layer or a protective layer laminated on the zeolite membrane 12, additionally to the support 11 and the zeolite membrane 12. Such a function layer or a protective layer may be an inorganic membrane such as the zeolite membrane, a silica membrane, a carbon membrane, or the like or an organic membrane such as a polyimide membrane, a silicone membrane, or the like. Further, a substance that is easy to adsorb water may be added to the function layer or the protective layer laminated on the zeolite membrane 12.

In the separation method, the separation of the mixed substance may be performed by a vapor permeation method, a reverse osmosis method, a gas permeation method, or the like other than the pervaporation method exemplarily shown in the above description. Further, any substance other than the substances exemplarily shown in the above description may be separated from the mixed substance.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The zeolite membrane complex of the present invention can be used, for example, as a dehydration membrane, and can be further used in various fields in which zeolite is used as a separation membrane for any of various substances other than water, an adsorption membrane for any of various substances, or the like.

### REFERENCE SIGNS LIST

1 Zeolite membrane complex
11 Support
12 Zeolite membrane
13 Low density layer
14 Dense layer
141 Zeolite crystals (of dense layer)
S11 to S13, S21, S22 Step

1. A zeolite membrane complex, comprising:
a porous support; and
a zeolite membrane formed on said support,
wherein said zeolite membrane comprises:
a low density layer covering said support; and
a dense layer covering said low density layer and having a content percentage of zeolite crystals higher than that of said low density layer,
and wherein an average aspect ratio of zeolite crystals contained in said dense layer is not smaller than 2 and not larger than 4 in a cross section of said zeolite membrane complex perpendicular to a surface of said support, and when a surface of said zeolite membrane which is a surface of said dense layer is observed from a direction perpendicular to said surface, 20% or more of zeolite crystals among zeolite crystals positioned on said surface each have a triangular shape.

2. The zeolite membrane complex according to claim 1, wherein
a ratio of zeolite crystals each having an aspect ratio of 3 or more, among zeolite crystals contained in said dense layer, is not lower than 10% in said cross section of said zeolite membrane complex.

3. The zeolite membrane complex according to claim 1, wherein
an average inclination angle of zeolite crystals contained in said dense layer in a longitudinal direction with respect to said surface of said support is not smaller than 60° and not larger than 90° in said cross section of said zeolite membrane complex.

4. The zeolite membrane complex according to claim 1, wherein
a length of a ridgeline on said surface of said zeolite membrane between two points separated from each other on said surface is 1.2 times or more as long as a distance between said two points in said cross section of said zeolite membrane complex.

5. The zeolite membrane complex according to claim 1, wherein
a Si/Al ratio of zeolite contained in said dense layer is 3 or more.

6. The zeolite membrane complex according to claim 1, wherein
zeolite contained in said dense layer is an 8-membered ring zeolite.

7. A separation method, comprising:
a) preparing the zeolite membrane complex according to claim 1; and
b) supplying a mixed substance containing a plurality of types of gases or liquids to said zeolite membrane complex and causing a substance with high permeability in said mixed substance to permeate said zeolite membrane complex, to be separated from any other substance.
